(19) United States
(12) Patent Application Publication
(10) Pub. No.: US 2017/0124514 A1
(43) Pub. Date: May 4, 2017

(54) PROJECT MANAGEMENT SYSTEM AND METHOD THEREOF

(71) Applicant: Hitachi, Ltd., Tokyo (JP)

(72) Inventors: Shota KASAI, Tokyo (JP); Hiroshi SAITOU, Tokyo (JP); Yuto YOSHIDA, Tokyo (JP); Takashi ISHIZAWA, Tokyo (JP)

(21) Appl. No.: 15/125,701

(22) PCT Filed: May 19, 2014
(86) PCT No.: PCT/JP2014/063240

§ 371 Date: Sep. 13, 2016

(51) Int. Cl. G06Q 10/10; G06F 17/30

(52) U.S. Cl. CPC G06Q 10/103; G06F 17/30082

(57) ABSTRACT

A project management system includes obtains an edit period of time of each of a plurality of files serving as a product of a project. The edit period of time ranges from a start of creation to a last update, and a grouping unit selects a second file whose creator and updater are the same as a creator of a first file included in meta information specifying each of the plurality of files and an updater of the first file included in an access log to the plurality of files and whose edit period of time at least partially overlaps the edit period of time of the first file. The first file and the selected second file are grouped, and the edit periods of time of the first file and the second file are output in association with the first file and the second file.

### TECHNICAL FIELD

The present invention relates to a project management system and a method thereof, and more particularly, to a management system of documents (files) created with the progress of a project and a method thereof.

### BACKGROUND ART

There is a method using a work breakdown structure (WBS) as one of project management methods. In this method, at a planning stage of a system development project, a project is managed such that works occurring in the entire project are divided into detailed works, a WBS serving as a configuration diagram indicating a the hierarchical structure of a work is created, and each of the divided works is developed up to a work process of each person in charge. A work of the WBS is indicated by a work or a product.

Regardless of the project management using the WBS, documents associated with the progress of system development or a system development project are managed by electronic data. Patent Document 1 discloses a technique of reflecting a change of an organization responsible for documents in a change of a category, focusing on that it is difficult to perform a document search although documents are classified into a plurality of categories. Specifically, Patent Document 1 discloses a technique of grouping documents that are similar in an access attribute and the number of accesses to documents into the same document group.

### CITATION LIST

### Patent Document

Patent Document 1: JP Hei6-209351 A

### SUMMARY OF THE INVENTION

### Problems to be Solved by the Invention

At a project planning or execution stage, it is useful to refer to or reuse configurations of documents of a project that exists already or documents themselves. Further, it is useful to refer to or reuse documents for management of a project that is in progress such as extraction of a progress state of a project or a bottleneck associated with a progress thereof. If a WBS is created again by reorganizing documents that exist already, usability can be further increased.

The technique disclosed in Patent Document 1 is a technique of reflecting a change or an organization responsible for documents in a change of a category in order to facilitate searching of documents of a project that exist already in the former. Thus, when the technique disclosed in Patent Document 1 is applied, a category of a document is changed based on access to a document, that is, a category of a document is changed, and thus it is considered to be suitable when individual documents are referred to. However, a configuration (WBS) of documents serving as a project which are created at the planning stage is broken up, and thus it is difficult to use a configuration of documents or documents themselves.

In the project management using the WBS, at the project planning stage, the WBS is created and developed onto a PERT chart, a Gantt chart, or the like, and each process of each work proceeds according to the chart. However, a document which is a product of each process does not correspond to a WBS that is originally created even when the technique disclosed in Patent Document 1 is not applied. One of causes thereof is a rework associated with a specification change of a development target or a test result of a development target. In order to cope with such a cause, it is necessary to update or upgrade document that is already created or create a new document according to circumstances. Meanwhile, particularly, there are cases in which a name of an upgraded document, a name of a document that is newly created, and a name of a product indicating such a document are arbitrarily given by a creator of a document. Further, there are cases in which a document serving as a product that is difficult to be associated with a work of the WBS such as a meeting minute or a note related to a project is also created and given an arbitrary name. Giving an arbitrary name makes it difficult to use a configuration of documents serving as a project or documents themselves.

In order to refer to or reuse it, it is desirable that it be possible to use a configuration of documents in which the substance of a project also including a document that does not correspond to the WBS is reflected or documents themselves. In this regard, it is desirable that it be possible to create a new WBS including even a document that does not correspond to the WBS.

### Solutions to Problems

A project management system according to the disclosure includes a storage device that stores a plurality of files serving as a product of a project, a file selecting unit that obtains an edit period of time of each of the plurality of files stored in the storage device, the edit period of time ranging from a start of creation to a last update, a grouping unit that selects a second file whose creator and updater are the same as a creator of a first file included in meta information specifying each of the plurality of files and an updater of the first file included in an access log to the plurality of files and whose edit period of time at least partially overlaps the edit period of time of the first file, and groups the first file and the selected second file, and an input/output unit that outputs the edit periods of time of the first file and the second file in association with the first file and the second file that are grouped.

### Effects of the Invention

According to a project management system of the disclosure, it is possible to use a configuration of documents in which the substance of a project is reflected.

### BRIEF DESCRIPTION OF THE DRAWINGS

FIG. 1 is a configuration diagram illustrating a project management system.

FIG. 2 illustrates a product file table.

FIG. 3 illustrates a product file access log.

FIG. 4 is a flowchart illustrating a process performed by a product management server.

FIG. 5 illustrates an exemplary setting item input screen.

FIG. 6 illustrates a product file table in which an edit period of time is added, and a creator (an operator) of a file is specified.

FIG. 7 illustrates an exemplary output to a screen of an input/output device by an input/output unit.

### MODE FOR CARRYING OUT THE INVENTION

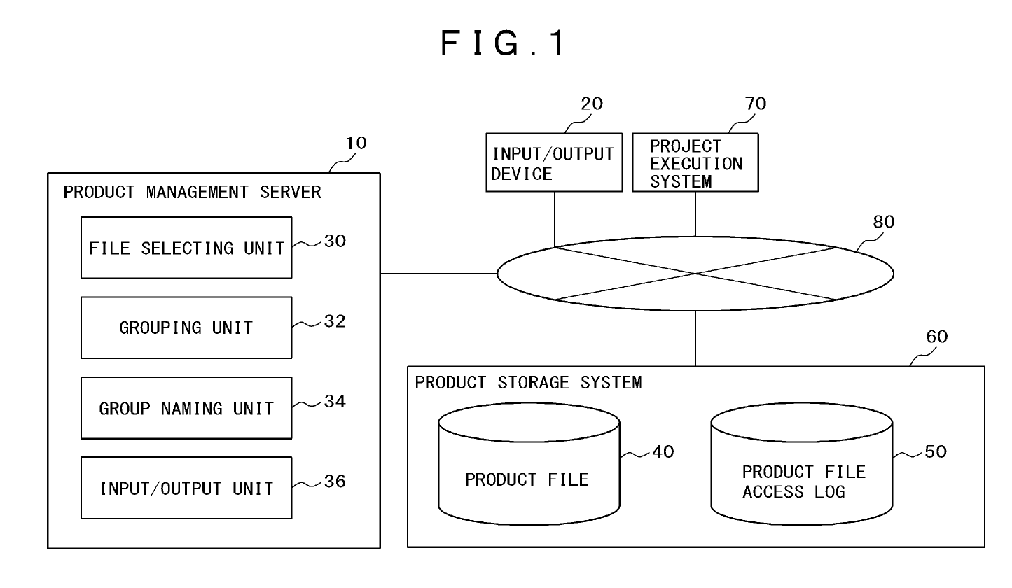

FIG. 1 is a configuration diagram illustrating a project management system according to an embodiment. The project management system includes a product management server 10, an input/output device 20, and a product storage system 60 that stores a file (product file) 40 serving as a product and a log (product file access log) 50 of access to the product file 40. The product management server 10 is connected with the product storage system 60 via a network 80.

A project execution system 70 is connected to the network 80, and the project execution system 70 stores files serving as products of a project in the product file 40. The project execution system 70 refers to the files stored in the product file 40 by its own and other project execution systems 70.

The files serving as products of a project are stored in the product file 40 together with meta information thereof, and A product file table (a file list) (which will be described later) is configured based on information included in the meta information and stored in the product storage system 60 by the product storage system 60.

Logs of accesses for storage and reference of files from the project execution system 70 to the product file 40 are recorded in a product file access log 50. As described above, the product storage system 60 operates as a database server or a file management system that performs control (exclusive control or the like) on access from the product management server 10 or the project execution system 70, and records the access in the product file access log 50. An operation of the database server or the file management system is already known, and thus a description thereof is omitted.

When a plurality of projects are managed in parallel, the product file 40, the product file table, and the product file access log 50 are configured in the product storage system 60 for each project.

The product management server 10 includes a file selecting unit 30 that obtains an edit period of time of each of a plurality of files stored in the product file 40 from a start of creation thereof to a last update thereof, a grouping unit 32 that selects another file whose creator and updater are the same as a creator of a certain file included in the meta information specifying each file and an updater of the certain file included in the product file access log 50 and in which the edit periods of time of the files overlaps at least partially, and groups the certain file and the selected another file, a group naming unit 34 that names a group in which a certain file and another file are grouped, and an input/output unit 36 that outputs the edit period of time of each file in association with a configuration of a group. The input/output unit 36 inputs setting items which will be described later.

Since it is possible to form a hierarchical structure of the files serving as products of a project through the grouping unit 32, it is possible to create a WBS in which a file stored in the product file 40 is used as a work.

The input/output device 20 is described as an input/output device equipped with a display device for projection management which is connected to the network 80 but may be connected to the product management server 10 or may be incorporated into the project execution system 100.

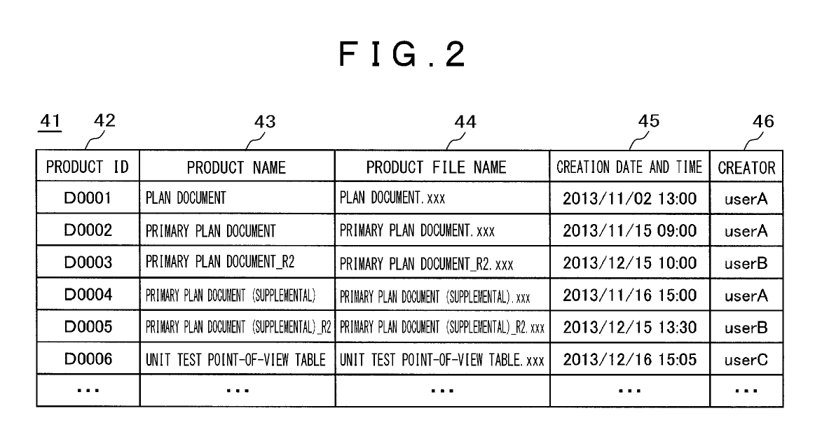

FIG. 2 illustrates a product file table 41 indicating a list of files stored in the product file 40, and although not illustrated in FIG. 1, the product file table 41 is stored in the product storage system 60 in association with the product file 40. The product file table 41 includes a product name 43 serving as a name of a product, a product file name 44, a creation date and time 45, and a creator 46 which are given by the project execution system 70 and a product ID 42 which is given by the product storage system 60 for each project execution system 70. For example, a product in which the product ID 42 is “D0001” is a product of a project D which is stored in the product file 40 at a 0001-st from the project execution system 70, the product name 43 is “plan document,” the product file name 44 is “plan document.xxx,” the creation date and time (an edit start date and time) 45 is “2013/11/02 13:00,” and the creator 46 is a “user A.”

Various names are given to the product name 43 and the product file name 44 with regard with a development target or a development scale of a project using the project execution system 70. In addition to the products illustrated in FIG. 2, there are a detailed design document including more detailed content than content of a primary design document, a structure design document related to hardware, a circuit design document, and the like. Further, there are a meeting minute, a note, and the like of a project. Here, for the sake of simplification of description, products of three stages of a plan document, a primary design document, and a unit test point-of-view table are described to be stored in the product file 40.

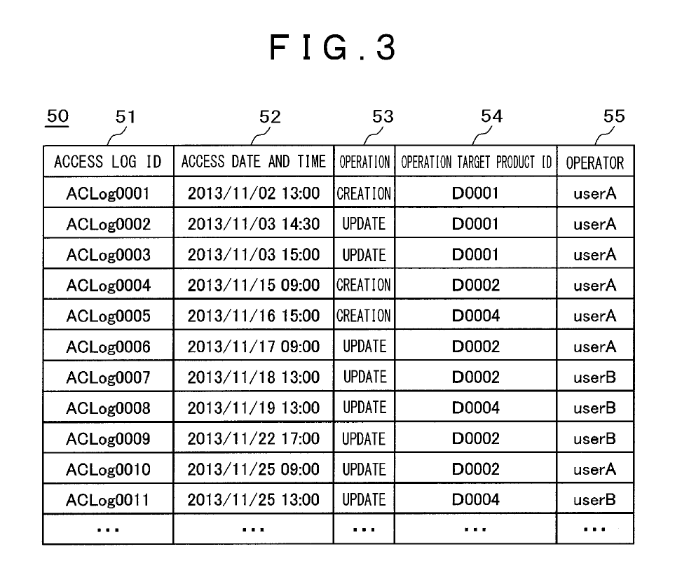

FIG. 3 illustrates the product file access log 50 in which logs of accesses (operations) for storages and reference of files from the project execution system 70 to the product file 40 are recorded. The product storage system 60 records an access log ID 51, an access date and time 52, an operation 53 serving as an access type, an operation target product ID 54, and an operator 55 in the product file access log 50 in an access order to the product file 40. FIG. 3 illustrates access logs to the products of the project D of the project execution system 70 for the sake of simplification. The product file access log 50 of each project execution system 70 is created by identifying a project (D at the head) indicated by the operation target product ID 54.

An example of content of the product file access log 50 illustrated in FIG. 3 is now described. The access log ID 51 of first access to the product of the project D of the project execution system 70 is “ACLog0001” and indicates a log in which the operator 55 of the “user A” performs the operation 53″ of creating (starting to edit) the operation target product ID 54 of “D0001” at the access date and time 52 “2013/11/02 13:00.” A type of the operation 53 is “creation (edit start)” (first storage of a product) and “update” (addition, deletion, or change of a product). When an approval for a product is included, an “approval” may be included in the operation 53. An identification method of the edit period of time of the product which will be described later differs according to whether or not the “approval” is included in the operation 53. When the approval is included, a period of time from “creation of the operation 53 to “approval” therefor is set as the edit period of time of the product, and when the approval is not included, a period of time from “creation” of the operation 53 to a last “update” is set as the edit period of time of the product. However, as will be described later, the edit period of time changes depending on a designated period of time for operating the project management system.

The description will continue with an example in which the access log ID 51 of the access of the product file access log 50 of FIG. 3 is “ACLog0004” to “ACLog0011.” In this example, “creation” and “update” are performed on “D0002” or “D0004” having the same operation target product ID 54 as the operation 53 is illustrated. In this example, the “user A” and the “user B” play a part in the “primary design document” in which the operation target product ID 54 is “D0002” and the “primary design document” (supplemental)” in which the operation target product ID 54 is “D0004” as the operator 55 (for example, a collaborative design work). However, access of the “user A” and access of the “user B” are exclusively controlled by the product storage system 60 so that the access date and times 52 are different.

In recent years, a system in which an access log corresponds to a file and is recorded in association with an update position of a file has been known. When a file is created and updated using this system, the product file access log 50 may not be provided, but in order to facilitate understand, the configuration including the product file 40 and the product file access log 50 is herein described.

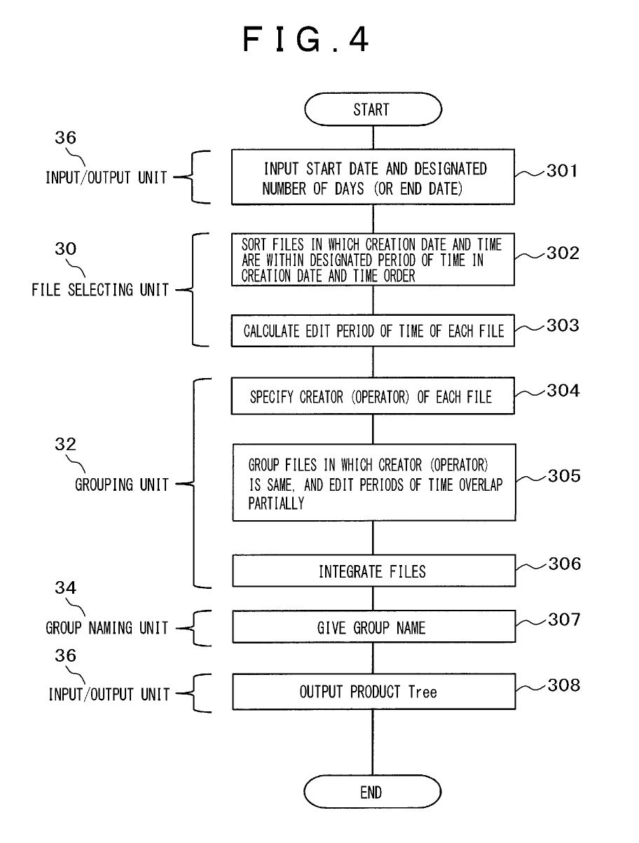

FIG. 4 is a flowchart illustrating a process performed by the product management server 10. As illustrated in FIG. 4, the product management server 10 performs the file selecting unit 30, the grouping unit 32, the group naming unit 34, and the input/output unit 36 as a series of processes. A target of the process performed by the product management server 10 is not limited to files stored in the product file 40 from the start of a project to the end thereof or the start of a project to a current point in time, and the product management server 10 copes with it more flexibly.

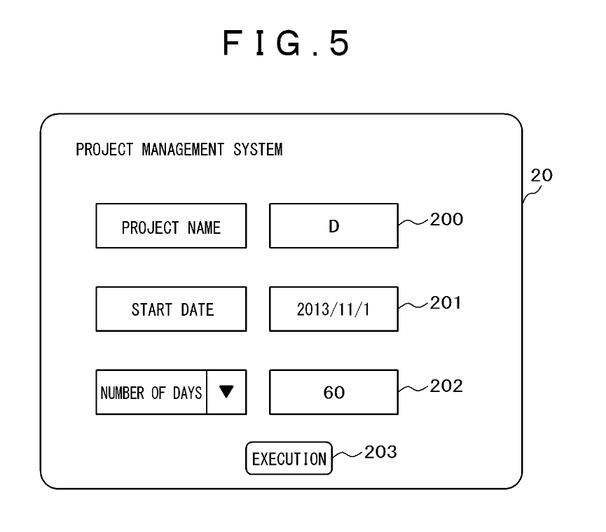

In order to cope with it more flexibly, the input/output unit 36 causes a setting item input screen associated with execution of the project management system to be displayed on the input/output device 20. FIG. 5 illustrates an exemplary setting item input screen. A project name 200, a start date 201, and a designated number of days (or an end date) 202 from a start date are input from the input/output device 20 (S301). The product management server 10 performs the process on a files that has the creation date and time (the edit start date and time) 45 and serves as the product of the project designated by the project name 200 in the designated period of time of from the input start date 201 to the end date (when a designated number of days is input, the end date is a date after the designated number of days from the start date). Thus, when the start date is set as a project start date, and the end date is set as a project end date, the entire period of time for projection execution is the designated period of time, and when a current time (a current day on which the project management system is operated) is set as the end date, a period of time from a project start to a current time is the designated period of time. The coping with it flexibly means, for example, that when files having the creation date and time (the edit start date and time) 45 during the past one year are set as a target, and when the progress state of the project is checked, the past one year is set as the designated period of time.

In response to pressing of an execution button 203 of the setting item input screen, the file selecting unit 30 selects a file in which the creation date and time (the edit start date and time) 45 is included in the designated period of time with reference to the product file table 41 stored in the product storage system 60, creates the product file table 41 related to the selected file in a storage unit of the product management server 10, and performs sorting in an creation date and time order (S302).

Here, the product file table 41 stored in the product storage system 60 and the product file table 41 created in the storage unit may differ in a period of time (the period of time in the product storage system 60 is from the project start date to the current time, and the period of time in the storage unit of the product management server 10 is a designated period of time) but have the same table structure, and FIG. 2 is also referred to for the description.

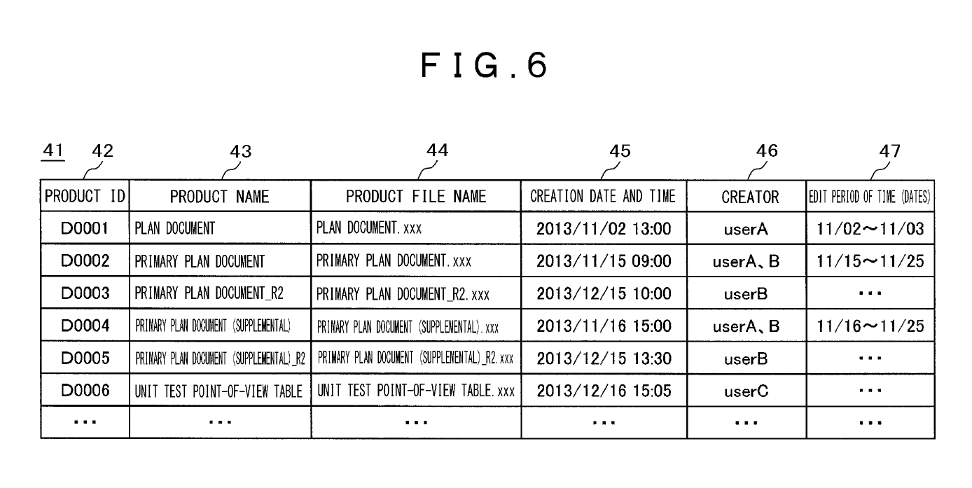

The file selecting unit 30 obtains the edit period of time of each file of the product file table 41 (S303). The obtained edit period of time adds a column of the edit period of time 47 to in the product file table 41 and stores the edit period of time 47 in the product file table 41. FIG. 6 illustrates the product file table 41 to which the column of the edit period of time 47 is added. Referring to with reference to the product file access log 50, the edit period of time 47 is a period of time from a first access date and time 52 to a last access date and time 52 within the designated period of time with respect with the same operation target product ID 54. FIG. 6 illustrates an example in which the edit period of time 47 is obtained on a daily basis, and in the case of the daily basis, it is a period of time from a first access date to a last access date.

The grouping unit 32 specifies a creator (operator) of each file, and adds the operator as the creator 46 in the case of a collaborative work (S304). In the case of the collaborative work, the operator is an operator 55 who has performed the operation 53 related to the same operation target product ID 54 with reference to the product file access log 50.

A specific example of specifying the creator (operator) will be described. FIG. 6 illustrates a result of specifying the creators (operators) of the respective files. Referring to the product file access log 50, the access log IDs 51 of “ACLog0001” to “ACLog0003” indicate accesses in which the product ID 42 of the product file table 41 is “D0001,” and the operator 55 of the accesses are all the “user A.” Thus, the creator 46 of the product file table 41 is the “user A.” Referring to the product file access log 50, the access log IDs 51 of “ACLog0004,” “ACLog0006,” “ACLog0007,” “ACLog0009,” and “ACLog0010” indicate accesses in which the product ID 42 of the product file table 41 is “D0002,” and the operator 55 of the accesses are the “user A” or the “user B.” The “user B” is added to the “user A” of the creator 46 of the product file table 41. Similarly, referring to the product file access log 50, access in which the product ID 42 of the product file table 41 is “D0004” is performed by the “user A” and the “user B.”

The grouping unit 32 groups files in which the creator 46 is the same, and the edit periods of time 47 thereof overlap at least partially with reference to the product file table 41 (S305). In the example illustrated in FIG. 6, files in which the creator 46 is the same are the “primary design document” in which the product ID 42 is “D0002” and the “primary design document” (supplemental)” in which the product ID 42 is “D0004,” the edit periods of time 47 thereof are “11/15 to 11/25” and “11/16 to 11/25,” and the edit periods of time 47 overlap at least partially, and thus the “primary design document” of “D0002” and the “primary design document” (supplemental)” of “D0004” are grouped. Although not illustrated, through the grouping of the “primary design document” and the “primary design document” (supplemental),” a “primary design document” which is a common part of a character string is used as a provisional name of the group.

When there is no other file in which the creator 46 is the same or in the case of files in which the creator 46 is the same, but the edit periods of time 47 thereof do not overlap at all, the product name 43 of the file is used as the provisional name of the group. In the example of FIG. 6, “plan document” in which the product ID 42 is “D0001” is an example in which there is no other file of the “user A” in which the creator 46 is the same. In the case of this example, “plan document” serving as the product name 43 is used as the provisional name of the group.

Further, there are cases in which the product name used as the provisional name of the group is unclear. Examples thereof include a meeting minute file of a meeting related to the progress state of the project and a comment file corresponding to a plurality of product names 4. In this case, “meeting minute” or “comment” of the product file name 44 is used as the provisional name of the group.

The grouping unit 32 integrates the groups (S306). The provisional name of the group is used for integrating the groups. As the provisional name of the group, in addition to the “primary design document” of the above-described example, a “primary design document “R2” is assumed to be grouped. In the case of this example, one provisional name “primary design document” is completely included in the other provisional name “primary design document “R2,” and in this case, they are integrated into one group.

As another example, there are cases in which name are partially identical such as “unit test point-of-view table” and “unit test case” as the provisional name of the group. In the case of this example, a front part of one provisional name “unit test point-of-view table” and a front part of the other provisional name “unit test case” are identical, and in this case, a group of a character string that is common to the provisional names is formed, and the group of the provisional name is hierarchized to be below the formed group.

The group naming unit 34 gives a name to each group (S307). The example in which the product name 43 or the product file name 44 is used as the provisional name of the group has been described, but in order to prevent confusion with the product name 43 or the product file name 44 used as the group name, a character string (for example, “creation”) is added. For example, primary design document “creation” is used as the group name of the provisional name “primary design document” of the group.

A group configuration in which the provisional name of the group or the group name is given with respect to the grouping is not illustrated, but the group configuration will be easily understood together with content stored in the storage unit of the product management server 10.

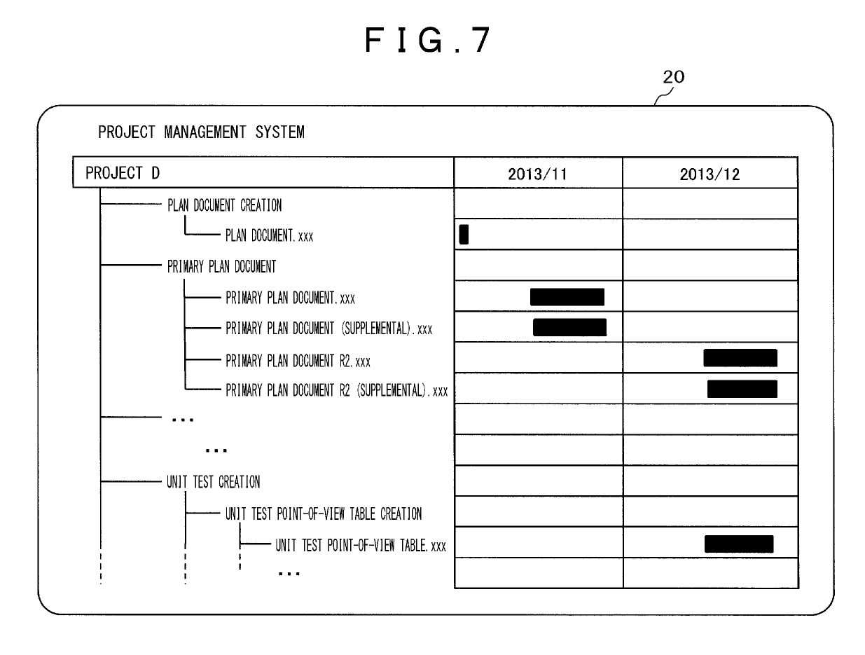

The input/output unit 36 causes the products of the project to be output on the screen of the input/output device 20 in a tree form (S308). FIG. 7 illustrates an output example to the input/output device 20. In the output example of FIG. 7, for the project D, names in which the products (works) are grouped and a hierarchical relation (WBS) of the products are displayed with a tree structure in association with the edit periods of time of the documents (files) constituting the tree structure.

Here, an example in which “meeting minute” and “comment” are used as the provisional name of the group, and “meeting minute” is a meeting minute of the “primary design document” is described as another example of the above-described grouping. The input/output unit 36 causes content illustrated in FIG. 7 to be output on the screen of the input/output device 20, and obtains confirmation of output content from an operator (a project manager in most situations) of the input/output device 20. When “meeting minute” is associated with the “primary design document” (for example, “meeting minute” is a meeting minute of the “primary design document”) (the output may be performed so that the operator can open a “meeting minute” file and confirms content thereof), the grouping unit 32 hierarchizes (integrates) a group names “meeting minute” or a file “meeting minute” to be put below the group name “primary design document” in response to an instruction input (a drag and drop operation of the group name or the file name) of the operator. A user interface for the hierarchization (integration) is understood as an existing technique.

As the display is performed as described above, a configuration (WBS) of documents serving as the project in which the substance of a project is reflected (that are actually created as the project) can be used, and the progress of the project is clearly understood since the edit period of time is displayed together.

Particularly, when the WBS is created at the planning stage of the project, it is possible to compare the WBS in which a file serving as a product that exists already is newly created as a work with the WBS of the planning stage, and a difference between the WBSs is recognized as reflecting the substance of project execution.

### REFERENCE SIGNS LIST

10 product management server

20 input/output device

30 file selecting unit

32 grouping unit

34 group naming unit

36 input/output unit

40 product file

41 product file table

50 product file access log

60 product storage system

70 project execution system

1. A project management system, comprising:
a storage device that stores a plurality of files serving as a product of a project;
a file selecting unit that obtains an edit period of time of each of the plurality of files stored in the storage device, the edit period of time ranging from a start of creation to a last update;
a grouping unit that selects a second file whose creator and updater are the same as a creator of a first file included in meta information specifying each of the plurality of files and an updater of the first file included in an access log to the plurality of files and whose edit period of time at least partially overlaps the edit period of time of the first file, and groups the first file and the selected second file; and
an input/output unit that outputs the edit periods of time of the first file and the second file in association with the first file and the second file that are grouped.

2. The project management system according to claim 1,
wherein the input/output unit causes a first group including the first file and the second file and a second group different from the first group to be displayed on the input/output device, and
in response to an instruction input given from the input/output device, the instruction input indicating an association of the second group with at least one of the first file and the second file, the grouping unit groups the second group into the first group.

3. The project management system according to claim 1,
wherein the input/output unit causes a first group including the first file and the second file and a third file included in a second group different from the first group to be displayed on the input/output device, and
in response to an instruction input given from the input/output device, the instruction input indicating an association of the third file with at least one of the first file and the second file, the grouping unit groups the third file into the first group.

4. The project management system according to claim 1, further comprising,
a group naming unit that names the group grouped by the grouping unit based on a character string that is common to a name of the first file and a name of the second file.

5. A project management method performed in a project management system including a storage device that stores a plurality of files serving as a product of a project, the method comprising:
obtaining an edit period of time of each of the plurality of files stored in the storage device, the edit period of time ranging from a start of creation to a last update;
selecting a second file whose creator and updater are the same as a creator of a first file included in meta information specifying each of the plurality of files and an updater of the first file included in an access log to the plurality of files and whose edit period of time at least partially overlaps the edit period of time of the first file;
grouping the first file and the selected second file; and
outputting the edit periods of time of the first file and the second file to an input/output device in association with the first file and the second file that are grouped.

6. The project management method according to claim 5,
wherein in the project management system, a first group including the first file and the second file and a second group different from the first group are displayed on the input/output device, and
in response to an instruction input given from the input/output device, the instruction input indicating an association of the second group with at least one of the first file and the second file, the grouping unit groups the second group into the first group.

7. The project management method according to claim 5,
wherein in the project management system, a first group including the first file and the second file and a third file included in a second group different from the first group are displayed on the input/output device, and
in response to an instruction input given from the input/output device, the instruction input indicating an association of the third file with at least one of the first file and the second file, the third file is grouped into the first group.

8. The project management method according to claim 5,
wherein in the project management system, a group into which the first file and the selected second file are grouped is named based on a character string that is common to a name of the first file and a name of the second file.
